(19) United States
(12) Patent Application Publication
(10) Pub. No.: US 2016/0372262 A1
(43) Pub. Date: Dec. 22, 2016

(54) Vehicle and Method of Manufacturing a Vehicle

(71) Applicant: BOMBARDIER PRIMOVE GmbH, Berlin (DE)

(72) Inventors: John Whaley, Filey (GB); Jing Gao, Viernheim (DE)

(21) Appl. No.: 15/118,917

(22) PCT Filed: Feb. 16, 2015
(86) PCT No.: PCT/EP2015/053233

§ 371 Date: Aug. 15, 2016

(30) Foreign Application Priority Data
Feb. 17, 2014 (GB) 1402761.9

(51) Int. Cl. H01F 27/36; H01F 38/14; B60L 11/18

(52) U.S. Cl. CPC H01F 27/36; B60L 11/182; H01F 38/14

(57) ABSTRACT

The invention relates to a vehicle. The vehicle includes at least one receiving device of a system for inductive power transfer, a cabin section, at least one shielding layer arranged between the receiving device and the cabin section, and a floor section. The at least one shielding layer is integrated into the floor section of the vehicle. The invention also relates to a method of manufacturing a vehicle.

The invention relates to a vehicle and to a method of manufacturing a vehicle.

While travelling on a route vehicles require energy for driving (i.e. propulsion) and for auxiliary equipment which does not produce propulsion of the vehicle. Such auxiliary equipment includes, for example, lighting system, heating and/or air conditioning systems, ventilation and passenger information systems. Not only track-bound vehicles (such as trams), but also road automobiles can be operated using electric energy. If continuous electric contact between the travelling vehicle and an electric rail or wire along the route is not desired, electric energy can be either withdrawn from an on-board energy storage or can be received by induction from an arrangement of electric lines of the route.

The transfer of electric energy to the vehicle by induction forms a background of the invention. A route-sided conductor arrangement (primary winding structure) of a primary-sided system of the system for inductive power transfer produces an electromagnetic field. The electromagnetic field is received by a secondary winding structure integrated into a receiving device on-board of the vehicle so that the field produces an electric voltage by induction. The transferred energy may be used for propulsion of the vehicle and/or for other purposes such as providing the auxiliary equipment of the vehicle with energy or charging an on-board energy storage. Such an inductive power transfer system is designed to deliver power efficiently from the stationary primary unit to one or more movable secondary units (receiving devices) over relatively large air gaps via magnetic coupling. To deliver the required power and to ensure equipment size remains manageable, it is usually necessary to operate at high frequencies, e.g. in the range of 20 kHz to 300 kHz.

The transfer of electric energy can be either performed while the vehicle is travelling (dynamic energy transfer) or while the vehicle is at a halt (static energy transfer).

Due to the high transfer power and the high operational frequency, an inductively coupled power transfer system usually generates a stray magnetic field inside the vehicle, e.g. in a cabin of the vehicle.

GB 2497822 A discloses a vehicle which includes a pickup coil arrangement mounted to an underside of a vehicle with an associated shield included above the pickup coil arrangement.

It is an object of the invention to reduce an exposure of passengers and/or objects in a cabin of the vehicle to a stray magnetic field generated during inductive power transfer while a number of components which has to be attached to an underside of the vehicle is reduced.

It is a main idea of the invention to arrange at least one, preferably more than one, shielding layer between a receiving device and a cabin section of the vehicle, wherein the at least one shielding layer is integrated into a floor section of the vehicle.

A vehicle is proposed. The vehicle can be a land vehicle, in particular a track-bound vehicle, such as a rail vehicle, e.g. a tram. Also, the vehicle can be a road automobile, such as an individual (private) passenger car or a public transport vehicle, e.g. a bus. The vehicle can also be a trolley bus or any other kind of vehicle.

The vehicle comprises at least one receiving device of a system for inductive power transfer. The receiving device can comprise a secondary winding structure for receiving an alternating electromagnetic field generated by a route-sided primary winding structure. The receiving device can be arranged at a bottom side or an underside of the vehicle.

Further, the vehicle comprises a cabin section. The cabin section can e.g. provide a passenger cabin or a cargo space of the vehicle.

Further, at least one shielding layer is arranged between the receiving device and the cabin section, in particular between the secondary winding structure and the cabin section. A shielding layer denotes an element which blocks or reduces an electromagnetic field. This means that if one side of the shielding layer is exposed to the electromagnetic field, no or only a reduced electromagnetic field, e.g. an electromagnetic filed with a reduced intensity, occurs at the other side of the shielding layer.

Further, the vehicle comprises a floor section. An upper outer surface of the floor section can e.g. provide a standing surface for passengers and/or load objects.

In the context of this invention, a reference coordinate system can be used in which a vertical axis is oriented perpendicular to the upper outer surface of the floor section and is oriented from said upper outer surface of the floor section towards a ceiling section of the vehicle. Also, the vertical direction can be oriented parallel to a main direction of extension of the electromagnetic field generated by the primary winding structure. A longitudinal axis can be oriented parallel to a longitudinal axis of the vehicle. A lateral axis can be oriented orthogonal to said vertical and said longitudinal axis. Terms referring to a direction, such as “upper”, “above”, “below” or “lower” can refer to said coordinate system.

Moreover, the vertical axis can be oriented parallel to a yaw axis of the vehicle, the longitudinal axis can be oriented parallel to a roll axis of the vehicle and the lateral axis can be oriented parallel to a pitch axis of the vehicle.

Further, the at least one shielding layer is integrated into the floor section of the vehicle. In other words, the at least one shielding layer provides a part of the floor section. More particular, the at least one shielding layer can provide an integral part of the floor section or can be attached or fixed to the floor section. The floor section, however, can additionally comprise other parts, e.g. other layers, in particular other wooden layers.

The at least one shielding layer can be arranged above the receiving device and below the cabin section. The floor section, e.g. at least one part of the floor section, can be attached to a vehicle chassis, in particular to at least one chassis beam of the vehicle chassis.

According to the invention, the at least one shielding layer comprises at least two separate layer elements. The at least two separate layer elements are arranged at different vertical positions along the vertical direction.

Also described is an embodiment, wherein the at least two separate layer elements can be arranged at the same vertical position along the vertical direction.

This advantageously simplifies a manufacturing of the at least one shielding layer since a shielding layer with predetermined (large) dimensions which is difficult to handle during an installation can be split up into multiple smaller layer elements.

Further, the at least two separate layer elements overlap at least partially. In this case, edge portions of the separate layer elements can overlap in a common plane of projection, which can be oriented orthogonal to the aforementioned vertical direction.

Also described is an embodiment, wherein the at least two separate layer elements butt against each other. In this case, at least one lateral edge or side face of a first layer element can butt against at least one lateral edge or side face of another layer element.

In each of the alternatives, the separate layer elements can be arranged such that there is no gap between the at least two separate layer elements. Thus, the at least one shielding layer provides a closed surface.

This, in turn, does not allow a stray magnetic field to extend in between two different layer elements of the at least one shielding layer and thus through the shielding layer along the vertical direction.

Thus, a vehicle is proposed in which passengers and/or objects located in a cabin section are not or only minimally exposed to stray fields which occur during inductive power transfer, wherein no additional installation space for a shielding element under the vehicle is required. This advantageously simplifies the manufacturing process of a vehicle with a receiving device and a corresponding shielding element.

In another embodiment, the at least one shielding layer is made of an electrically conductive material. In particular, the at least one shielding layer can be made of aluminium or, preferably, stainless steel. This advantageously provides good shielding characteristics.

In a preferred embodiment, the vehicle comprises at least two shielding layers, wherein each of the at least two shielding layers is arranged between the receiving device and the cabin section, wherein the shielding layers are spatially separated, in particular along the aforementioned vertical direction. In this case, each of the shielding layers can be integrated into the floor section, e.g. provide a part of the floor section. The feature of spatial separation does not exclude that different shielding layers are connected, in particular electrically and/or mechanically, by at least one connection means, e.g. a connecting section such as a connecting rod.

In the case of multiple shielding layers, it is not a mandatory feature that at least one or even all shielding layer(s) is/are integrated into the floor section. Thus, a vehicle is described, wherein the vehicle comprises at least one receiving device of a system for inductive power transfer, wherein the vehicle further comprises a cabin section, wherein at least two shielding layers are arranged between the receiving device and the cabin section, wherein the shielding layers are spatially separated, in particular along the aforementioned vertical direction.

The at least two shielding layers, e.g. outer surfaces or outer surface sections, can be spaced apart from one another with a predetermined vertical distance. In this case, the at least two shielding layers can be oriented parallel to each other but at different vertical positions within the floor section. Also, the shielding layers can be oriented parallel to an upper surface of the floor section of the cabin section. Each of the shielding layers can have a predetermined length which is measured along the aforementioned longitudinal direction, a predetermined width which is measured along the aforementioned lateral direction and a predetermined height, i.e. thickness, which is measured along the vertical direction.

Using more than one shielding layer advantageously allows reducing a thickness of the shielding layers. More particular, a resulting thickness of all shielding layers, i.e. a sum of the thicknesses of all shielding layers, can be smaller than a thickness of a single shielding layer while the same shielding characteristics are provided. This, in turn, advantageously allows reducing manufacturing costs, spatial requirements and a weight of the shielding means of the vehicle.

In particular, two or three shielding layers can be used, wherein all shielding layers are integrated into the floor section, e.g. provide parts of the floor section.

In another embodiment, the different shielding layers overlap in a common plane of projection at least partially, preferably fully. The common plane of projection can be plane perpendicular to the aforementioned vertical direction. In particular, the different shielding layers can have an equal width and an equal length. It is possible that the different shielding layers have an equal thickness. However, it is also possible that the thickness of at least one shielding layer differs from the thickness of at least one other shielding layer of the set of shielding layers.

As the main direction of extension of the electromagnetic field generated by the primary winding structure and received by the secondary winding structure is usually oriented parallel to the aforementioned vertical direction, the proposed arrangement ensures that the electromagnetic field extends through multiple shielding elements along said direction of propagation. Thus, the electromagnetic stray field is effectively reduced or even fully blocked.

In another embodiment, the at least one shielding layer provides a top layer of the floor section. The at least one shielding layer can e.g. be arranged above all other layers of the floor section. In this case, the at least one shielding layer can provide the aforementioned upper outer surface of the floor section, e.g. the standing surface for passenger and/or load objects.

Alternatively, the at least one shielding layer provides a bottom layer the floor section. The at least one shielding layer can e.g. be arranged below all other layers of the floor section. In this case, another part or layer of the floor section, e.g. a wooden part or layer, can provide the upper outer surface.

Alternatively, the at least one shielding layer can provide an intermediate layer of the floor section. The at least one shielding layer can e.g. be arranged between two other layers of the floor section. In this case, the floor section can e.g. comprise at least two other parts or layers, e.g. wooden parts or layers, which are arranged above or below the at least one shielding layer. This provides a sandwich construction.

In particular, the at least one shielding layer can be mechanically attached to other parts or portions of the floor section.

If more than one shielding layer is used, one shielding layer can provide the top layer, wherein the other shielding layer provides the bottom layer or an intermediate layer of the floor section. This advantageously allows a simple integration of multiple shielding layers which are spatially separated into the floor section.

In a preferred embodiment, the vehicle comprises a vehicle chassis, wherein the at least one shielding layer is electrically connected to the vehicle chassis. Thus, induced currents within the at least one shielding layers can be conducted away from the at least one shielding layer.

In another preferred embodiment, the vehicle comprises a vehicle chassis, wherein the at least one shielding layer is mechanically connected to the vehicle chassis. In particular, the at least one shielding layer can be mechanically connected to a chassis beam of the vehicle chassis, in particular to a chassis beam which extends along the aforementioned longitudinal direction. Different connection means can be used. It is e.g. possible to attach the at least one shielding layer to the vehicle chassis by at least one screw, preferably multiple screws, by at least one bolt, or by at least one blank. It is also possible to weld the at least one shielding layer together with the vehicle chassis. In this case, the welding should preferably be made continuously. The mechanical connection means can also provide at least a part of the electrical connection means.

Thus, the weight of the at least one shielding layer which is added to the vehicle, can be directly transferred to the vehicle chassis.

In another preferred embodiment, the vehicle comprises a vehicle chassis, wherein the at least one shielding layer is arranged below at least a part of the vehicle chassis. In particular, the at least one shielding layer can be arranged below a chassis beam, in particular a chassis beam which extends along the longitudinal direction. In this case, the induction of eddy currents within the chassis can be effectively reduced or even eliminated.

In another embodiment, the at least one shielding layer has a length which is higher than or equal to a length of a secondary winding structure of the vehicle and/or a width which is higher than or equal to a width of a secondary winding structure of the vehicle. Preferably, the at least one shielding layer has a length which is higher than a length of a corresponding primary winding structure and/or a width which is higher than a width of a corresponding primary winding structure. The corresponding primary winding structure denotes a primary winding structure which is used to generate the alternating electromagnetic field. In other words, the at least one shielding layer can have a length which is higher than a length of the secondary winding structure within the receiving device and/or width which is higher than the width of the secondary winding structure and a predetermined offset value, wherein the offset value is in each case larger than zero. The offset value can reflect the deviation between the length of a primary winding structure and the secondary winding structure and/or a parking tolerance, in particular a parking tolerance along the longitudinal and lateral direction, e.g. along the aforementioned longitudinal and lateral axis, respectively.

The length and the width of a winding structure can denote a maximal length and a maximal width of an envelope of the winding structure within a plane which is orthogonal to the vertical direction.

Preferably, the at least one shielding layer has a width which is equal to a width of the vehicle, in particular of the vehicle chassis.

Further proposed is a method of manufacturing a vehicle, wherein the method comprises at least the steps of:
providing a cabin section, e.g. a cabin section with a floor section,
providing a receiving device,
arranging the receiving device below the cabin section,
providing at least one shielding layer,
arranging the at least one shielding layer between the cabin section and the receiving device, wherein the at least one shielding layer is integrated into the floor section of the vehicle.

The at least one shielding layer comprises at least two separate layer elements, wherein the at least two separate layer elements are arranged at different vertical positions along a vertical direction, wherein the at least two separate layer overlap at least partially. This means that the method can comprise the steps of providing at least two separate layer elements and arranging the at least two separate layer elements at different vertical positions along a vertical direction, wherein the at least two separate layer overlap at least partially.

This advantageously allows manufacturing a vehicle according to one of the previously described embodiments. In particular, the proposed method of manufacturing a vehicle can comprise all steps which are required to provide a vehicle according to one of the previously described embodiments.

In another embodiment, at least two shielding layers are provided, wherein each of the shielding layers is arranged between the cabin section and the receiving device. Further, each of the shielding layers can be integrated into the floor section of the vehicle.

Further described is a vehicle chassis, wherein at least one shielding layer is mechanically and/or electrically connected to the vehicle chassis. The vehicle chassis provides a chassis of the vehicle, wherein the vehicle comprises a cabin section and a receiving device of a system for inductive power transfer. The at least one shielding layer is arranged with respect to the vehicle chassis such that the at least one shielding layer is arranged between the receiving device and the cabin section. Further, the at least one shielding layer can be integrated into the floor section.

Examples and preferred embodiments of the invention will be described with reference to the attached figures which show:

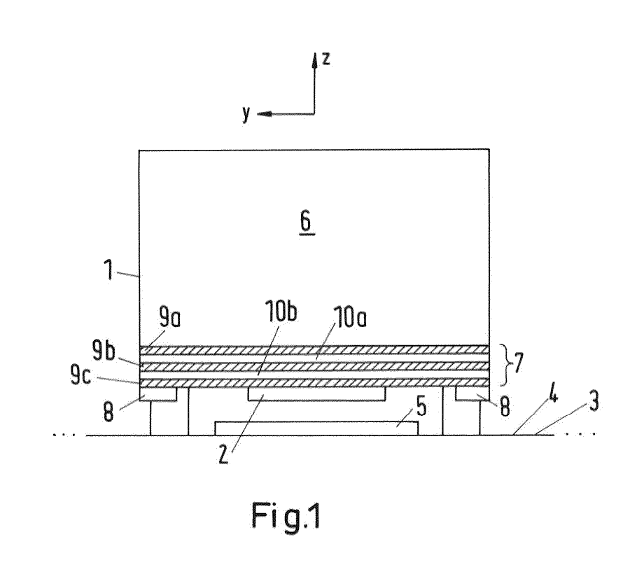

FIG. 1 a schematic cross section of a vehicle,

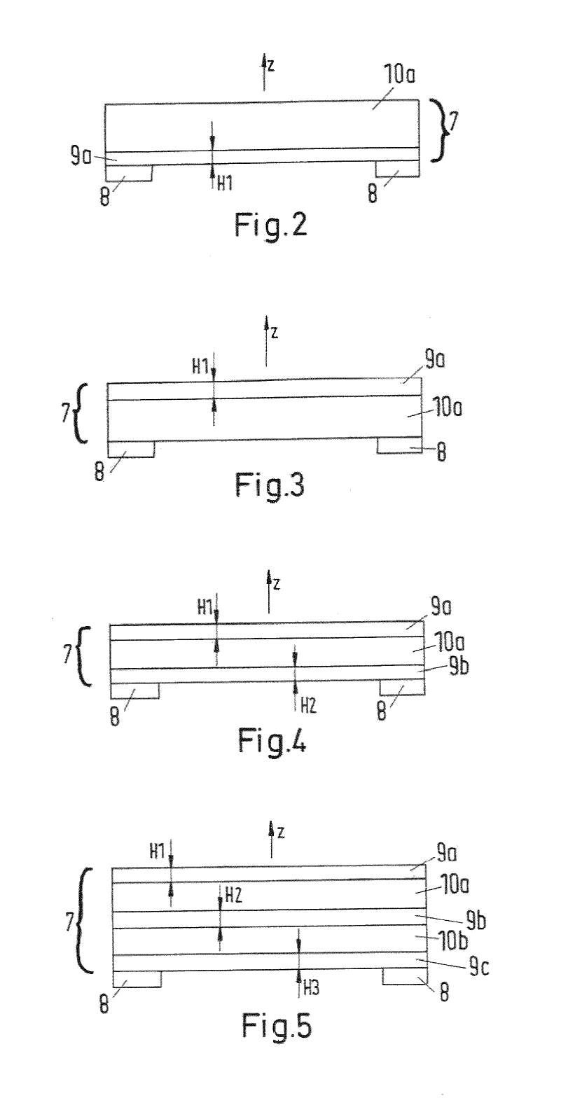

FIG. 2 a schematic cross section of a floor section of the vehicle according to a first embodiment,

FIG. 3 a schematic cross section of a floor section of the vehicle according to a second embodiment,

FIG. 4 a schematic cross section of a floor section of the vehicle according to a third embodiment,

FIG. 5 a schematic cross section of a floor section of the vehicle according to a fourth embodiment and

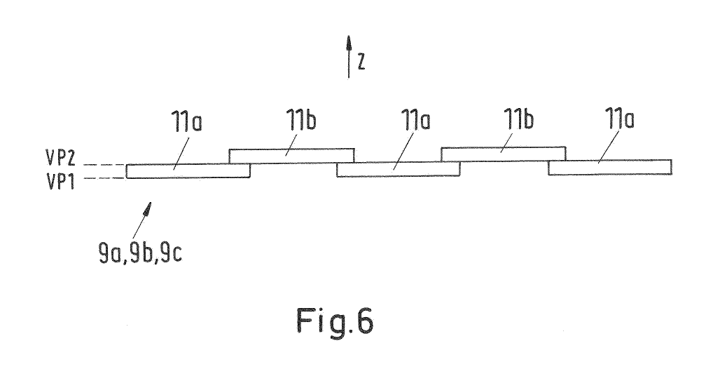

FIG. 6 a schematic cross section of a shielding layer.

FIG. 1 shows a schematic cross section of a vehicle 1. The vehicle 1 comprises at least one receiving device 2 which comprises a secondary winding structure (not shown). Further shown is that the vehicle 1 is standing on a surface 3 of a route 4. A primary unit 5, which can e.g. be designed as a charging pad, is installed on the surface 3. It can be seen that the receiving device 2 is located above the primary unit 5 along a vertical direction z.

The vehicle 1 comprises a cabin section 6 and a floor section 7.

The floor section 7 is mechanically connected to chassis beams 8 of a vehicle chassis. The floor section 7 further comprises a first shielding layer 9a, a second shielding layer 9b and a third shielding layer 9c which are spaced apart from another with a predetermined distance along the vertical direction z. Further, the floor section 7 comprises a first wooden layer 10a and second wooden layer 10b. The first wooden layer 10a is arranged between the first and the second shielding layer 9a, 9b. The second wooden layer 10b is arranged between the second and the third shielding layer 9b, 9c. An upper outer surface of the first shielding layer 9a provides a standing surface of the cabin section 6. The shielding layers 9a, 9b, 9c and the wooden layer 10a, 10b can be mechanically connected.

Further, at least one shielding layer 9a, 9b, 9c can be mechanically and/or electrically connected to at least one chassis beam 8. Further, all different shielding layers 9a, 9b, 9c can be electrically connected.

It is shown that a width of each shielding layer 9a, 9b, 9c which is measured along a lateral axis y is larger than a width of the primary unit 5 and a width of the receiving device 2. Not shown is that a length of each shielding layer 9a, 9b, 9c is larger than a length of the primary unit 5 and a length of the receiving device 2, wherein the length is measured along a longitudinal axis which is oriented orthogonal to the vertical direction z and the lateral direction y and points into the plane of projection.

The shielding layers 9a, 9b, 9c can e.g. be made of stainless steel.

FIG. 2 shows a schematic cross section of a floor section 7 of a vehicle 1 (see FIG. 1). In this embodiment, a shielding layer 9a is arranged below a wooden layer 10a and above chassis beams 8. A thickness H1 of the single shielding layer 9a is indicated, wherein the thickness is measured along the vertical direction z. The shown thickness H1 can e.g. be 2 mm.

FIG. 3 shows a schematic cross section of a floor section 7 of a vehicle 1 (see FIG. 1) according to a second embodiment. In this embodiment, a single shielding layer 9a is arranged above a wooden layer 10a. A thickness H1 is also indicated, wherein the thickness H1 of the single shielding layer 9a shown in FIG. 3 can be equal to the thickness H1 of the single shielding layer 9a shown in FIG. 2.

A resulting weight of the shielding layers 9a shown in FIG. 2 and FIG. 3 can thus be equal.

FIG. 4 shows a schematic cross section of a floor section 7 of a vehicle 1 (see FIG. 1) according to a third embodiment. The floor section 7 comprises a first shielding layer 9a and a second shielding layer 9b, wherein the first shielding layer 9a is arranged above a wooden layer 10a and the second shielding layer 9b is arranged below the wooden layer 10a. Further indicated are thicknesses H1, H2 of the shielding layers 9a, 9b. In this case, the thicknesses H1, H2 of each of the shielding layers 9a, 9b can be smaller than half of the thickness H1 of the shielding layers 9a shown in FIG. 2 and FIG. 3. The thicknesses H1, H2 of the shielding layers 9a, 9b, 9c shown in FIG. 4 can e.g. be 0.5 mm.

Thus, a resulting thickness which is a sum of the thicknesses H1, H2 of the shielding layers 9a, 9b shown in FIG. 4 is smaller than the thickness H1 of the shielding layers 9a shown in FIG. 2 and FIG. 3. In general, the summed thicknesses H1, H2 of multiple shielding layers 9a, 9b can be smaller than a thickness H1 of a single shielding layer 9a, wherein the arrangement of multiple shielding layers 9a, 9b provides at least the same or even better shielding characteristics as the single shielding layer 9a. Thus, a total weight of all shielding layers 9a, 9b is reduced if compared to the embodiments shown in FIG. 2 and FIG. 3. However, the embodiment shown in FIG. 4 can provide the same shielding characteristics, i.e. the same or even a higher reduction of the stray electromagnetic field, as the embodiments shown in FIG. 2 and FIG. 3.

In FIG. 5, a schematic cross section of a floor section 7 of a vehicle 1 (see FIG. 1) according to a fourth embodiment is shown. The floor section 7 shown in FIG. 5 corresponds to the floor section 7 shown in FIG. 1. Further indicated are thicknesses H1, H2, H3 of the shielding layers 9a, 9b, 9c. The thicknesses H1, H2, H3 can each be smaller than ⅓ of the thickness H1 of the shielding layer 9a shown in FIG. 2 and in FIG. 3 and also smaller than the thickness H1, H2 of shielding layers 9a, 9b shown in FIG. 4. The thicknesses H1, H2, H3 of the shielding layers 9a, 9b, 9c shown in FIG. 5 can e.g. be 0.1 mm. Thus, the shown triple-layer arrangement further allows reducing a resulting weight of the shielding layers 9a, 9b, 9c.

The shielding layers 9a, 9b, 9c shown in FIG. 1 to FIG. 5 can be fastened to the vehicle chassis, in particular to the chassis beams 8. However, it is preferred to provide no break or gap between different shielding layer elements when viewed from the primary unit, wherein one shielding layer 9a, 9b, 9c is provided by multiple shielding layer elements 11a, 11b (see FIG. 6). The shielding layers 9a, 9b, 9c can be mechanically connected to the chassis at multiple connection points, which can e.g. be spaced apart with a maximal distance of 0.1 m.

The shown embodiments provide a volume with low magnetic fields inside the vehicle 1 and thus a good protection for a vehicle driver and passengers.

FIG. 6 shows a schematic cross section of a shielding layer 9a, 9b, 9c which can be part of one of the embodiments shown in FIGS. 1 to 5.

The shielding layer 9a, 9b, 9c comprises multiple shielding layer elements 11a, 11b. A first set of layer elements 11a is arranged at a first vertical position VP1 along a vertical direction z. Another set of layer elements 11b is arranged at another vertical position VP2 along the vertical direction z. The vertical positions VP1, VP2 are defined as the vertical position of a bottom side of the layer elements 11a, 11b.

The shielding layer elements 11a, 11b overlap at least partially, in particular adjacent layer elements 11a, 11b of the first set and the other set. The overlap is provided in a common plane of projection which is oriented perpendicular to the vertical direction z. It is shown that shielding layer elements 11a, 11b overlap in a peripheral section of the layer elements 11a, 11b.

It is further shown that a bottom side of a shielding layer element 11b of the other set butts against a top side of one or two shielding layer element(s) 11a of the first set. It is, however, also possible, that a bottom side of a shielding layer element 11b of the other set is arranged with a non-zero spatial distance away from the top side of one or two shielding layer element(s) 11a of the first set.

The shielding layer elements 11a, 11b can be mechanically fixed together.

In FIG. 6, the first set of layer elements 11a comprises three elements 11a, wherein the other set of layer elements 11b comprises two elements 11b. It is, however, possible to choose any other number equal or higher than one.

1. A vehicle comprising: at least one receiving device of a system for inductive power transfer; a cabin section; at least one shielding layer arranged between the receiving device and the cabin section; and a floor section, wherein the at least one shielding layer is integrated into the floor section of the vehicle,
wherein
the at least one shielding layer comprises at least two separate layer elements, wherein the at least two separate layer elements are arranged at different vertical positions along a vertical direction, wherein the at least two separate layer elements overlap at least partially, and
wherein the at least two separate layer elements abut against each other.

2. The vehicle according to claim 1, wherein the at least one shielding layer is made of an electrically conductive material.

3. The vehicle according to claim 1, wherein the vehicle comprises at least two shielding layers, wherein each of the at least two shielding layers is arranged between the receiving device and the cabin section, wherein the at least two shielding layers are spatially separated.

4. The vehicle according to claim 3, wherein the at least two shielding layers overlap in a common plane of projection at least partially.

5. The vehicle according to claim 1, wherein the at least one shielding layer provides a top layer, a bottom layer or an intermediate layer of the floor section.

6. The vehicle according to claim 1, wherein the vehicle further comprises a vehicle chassis, wherein the at least one shielding layer is electrically connected to the vehicle chassis.

7. The vehicle according to claim 1, wherein the vehicle further comprises a vehicle chassis, wherein the at least one shielding layer is mechanically connected to the vehicle chassis.

8. The vehicle according to claim 1, wherein the vehicle further comprises a vehicle chassis, wherein the at least one shielding layer is arranged below at least a part of the vehicle chassis.

9. The vehicle according to claim 1, wherein the at least one shielding layer has a length which is greater than or equal to a length of a secondary winding structure and/or a width which is greater than or equal to a width of a secondary winding structure.

10. A method of manufacturing a vehicle, the method comprising the steps of:
providing a cabin section,
providing a receiving device,
arranging the receiving device below the cabin section,
providing at least one shielding layer,
arranging the at least one shielding layer between the cabin section and the receiving device, wherein the at least one shielding layer is integrated into a floor section of the vehicle, wherein a shielding layer comprises at least two separate layer elements, wherein the at least two separate layer elements are arranged at different vertical positions along a vertical direction, wherein the at least two separate layer elements overlap at least partially.

11. The method according to claim 10, wherein at least two shielding layers are provided, wherein each of the shielding layers is arranged between the cabin section and the receiving device.
